(19) United States
(12) Patent Application Publication
(10) Pub. No.: US 2026/0120408 A1
(43) Pub. Date: Apr. 30, 2026

(54) DISENTANGLED NETWORK ARCHITECTURE FOR ACCURATE REPRESENTATIONS OF FACIAL AVATARS

(71) Applicant: QUALCOMM Incorporated, San Diego, CA (US)

(72) Inventors: Mohit LAMBA, New Delhi (IN); Anupama S, Chennai (IN); Srenivas VARADARAJAN, Bangalore (IN)

(21) Appl. No.: 19/084,654

(22) Filed: Mar. 19, 2025

Related U.S. Application Data
(60) Provisional application No. 63/714,034, filed on Oct. 30, 2024.

(51) Int. Cl. G06T 17/20

(52) U.S. Cl. CPC G06T 17/205

(57) ABSTRACT

Systems and techniques are provided for generating a mesh model. For instance, a process can include: generating, based on a plurality of frames, a first portion of a parametric model of a face using a first machine learning (ML) model; generating, based on the plurality of frames, a second portion of the parametric model of the face using a second ML model, wherein the first portion of the parametric model is generated independently from the second portion of the parametric model; merging the first portion of the parametric model and the second portion of the parametric model to generate the parametric model; and outputting the parametric model.

### CROSS-REFERENCE TO RELATED APPLICATIONS

This application claims the benefit of U.S. Provisional Patent Application No. 63/714,034, filed Oct. 30, 2024, which is hereby incorporated by reference in its entirety and for all purposes.

### FIELD

The present disclosure generally relates to systems and techniques for generating three-dimensional (3D) models. For example, aspects of the present disclosure relate to a technique for a disentangled machine learning (ML) network architecture for accurate representation of facial avatars.

### BACKGROUND

Many devices and systems allow a scene to be captured by generating frames (also referred to as images) and/or video data (including multiple images or frames) of the scene. For example, a camera or a computing device including a camera (e.g., a mobile device such as a mobile telephone or smartphone including one or more cameras) can capture a sequence of frames of a scene. The frames and/or video data can be captured and processed by such devices and systems (e.g., mobile devices, IP cameras, etc.) and can be output for consumption (e.g., displayed on the device and/or other device). In some cases, the frame and/or video data can be captured by such devices and systems and output for processing and/or consumption by other devices.

A frame can be processed (e.g., using object detection, recognition, segmentation, etc.) to determine objects that are present in the frame, which can be useful for many applications. For instance, a model can be determined for representing an object in a frame and can be used to facilitate effective operation of various systems. Examples of such applications and systems include augmented reality (AR), robotics, automotive and aviation, three-dimensional scene understanding, object grasping, object tracking, in addition to many other applications and systems.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In one illustrative example, an apparatus for generating a mesh model is provided. The apparatus includes at least one memory and at least one processor coupled to the at least one memory. The at least one processor is configured to: obtain a plurality of frames, wherein each frame includes a portion of a face; generate, based on the plurality of frames, a parametric model using a machine learning (ML) model, wherein the ML model is configured to generate information for a first portion of the parametric model corresponding to a first portion of the face, the first portion of the parametric model being independent from information for a second portion of the parametric model corresponding to a second portion of the face; and output the parametric model.

As another example, a method for generating a mesh model is provided. The method includes: obtaining a plurality of frames, wherein each frame includes a portion of a face; generating, based on the plurality of frames, a parametric model using a machine learning (ML) model, wherein the ML model is configured to generate information for a first portion of the parametric model corresponding to a first portion of the face, the first portion of the parametric model being independent from information for a second portion of the parametric model corresponding to a second portion of the face; and outputting the parametric model.

In another example, a non-transitory computer-readable medium having stored thereon instructions is provided. The instructions, when executed by at least one processor, cause the at least one processor to: obtain a plurality of frames, wherein each frame includes a portion of a face; generate, based on the plurality of frames, a parametric model using a machine learning (ML) model, wherein the ML model is configured to generate information for a first portion of the parametric model corresponding to a first portion of the face, the first portion of the parametric model being independent from information for a second portion of the parametric model corresponding to a second portion of the face; and output the parametric model.

As another example, an apparatus for generating a mesh model is provided. The apparatus includes: means for obtaining a plurality of frames, wherein each frame includes a portion of a face; means for generating, based on the plurality of frames, a parametric model using a machine learning (ML) model, wherein the ML model is configured to generate information for a first portion of the parametric model corresponding to a first portion of the face, the first portion of the parametric model being independent from information for a second portion of the parametric model corresponding to a second portion of the face; and means for outputting the parametric model.

In another example, an apparatus for generating a mesh model is provided. The apparatus includes at least one memory and at least one processor coupled to the at least one memory. The at least one processor is configured to: generate, based on a plurality of frames, a first portion of a parametric model of a face using a first machine learning (ML) model; generate, based on the plurality of frames, a second portion of the parametric model of the face using a second ML model, wherein the first portion of the parametric model is generated independently from the second portion of the parametric model; merge the first portion of the parametric model and the second portion of the parametric model to generate the parametric model; and output the parametric model.

In some aspects, a method for generating a mesh model is provided. The method includes: generating, based on a plurality of frames, a first portion of a parametric model of a face using a first machine learning (ML) model; generating, based on the plurality of frames, a second portion of the parametric model of the face using a second ML model, wherein the first portion of the parametric model is generated independently from the second portion of the parametric model; merging the first portion of the parametric model and the second portion of the parametric model to generate the parametric model; and outputting the parametric model.

In another example, a non-transitory computer-readable medium having stored thereon instructions is provided. The instructions, when executed by at least one processor, cause the at least one processor to: generate, based on a plurality of frames, a first portion of a parametric model of a face using a first machine learning (ML) model; generate, based on the plurality of frames, a second portion of the parametric model of the face using a second ML model, wherein the first portion of the parametric model is generated independently from the second portion of the parametric model; merge the first portion of the parametric model and the second portion of the parametric model to generate the parametric model; and output the parametric model.

In another example, an apparatus for generating a mesh model is provided. The apparatus includes: means for generating, based on a plurality of frames, a first portion of a parametric model of a face using a first machine learning (ML) model; means for generating, based on the plurality of frames, a second portion of the parametric model of the face using a second ML model, wherein the first portion of the parametric model is generated independently from the second portion of the parametric model; means for merging the first portion of the parametric model and the second portion of the parametric model to generate the parametric model; and means for outputting the parametric model.

In some aspects, one or more of the apparatuses described above is or is part of a vehicle (e.g., a computing device of a vehicle), a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, or other device. In some aspects, an apparatus includes a camera or multiple cameras for capturing one or more images. In some aspects, the apparatus further includes a display for displaying one or more images, notifications, and/or other displayable data. In some aspects, the apparatus can include one or more sensors, which can be used for determining a location and/or pose of the apparatus, a state of the apparatuses, and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 illustrates an example three-dimensional (3D) facial model and corresponding two-dimensional (2D) facial images overlaid with landmarks projected from the 3D facial model, in accordance with some examples;

FIG. 2 illustrates an example head mounted XR system with user facing cameras for generating a 3D facial model, in accordance with some examples;

FIG. 3 is a diagram illustrating an example of a 3D modeling system, in accordance with some examples;

FIG. 4 is a block diagram illustrating a technique for facial blendshape avatars, in accordance with aspects of the present disclosure;

FIG. 5 illustrates an architecture for training a disentangled ML network architecture, in accordance with aspects of the present disclosure;

FIG. 6 illustrates a flowchart of a process for generating a mesh model, in accordance with aspects of the present disclosure;

FIG. 7 is a block diagram illustrating an example of a deep learning network, in accordance with some examples;

FIG. 8 is a block diagram illustrating an example of a convolutional neural network, in accordance with some examples; and

FIG. 9 is a diagram illustrating an example of a system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The generation of three-dimensional (3D) models for physical objects can be useful for many systems and applications, such as for extended reality (XR) (e.g., including augmented reality (AR), virtual reality (VR), mixed reality (MR), etc.), robotics, automotive, aviation, 3D scene understanding, object grasping, object tracking, in addition to many other systems and applications. In AR environments, for example, a user may view images (also referred to as frames) that include an integration of artificial or virtual graphics with the user's natural surroundings. AR applications allow real images to be processed to add virtual objects to the images or to display virtual objects on a see-through display (so that the virtual objects appear to be overlaid over the real-world environment). AR applications can align or register the virtual objects to real-world objects (e.g., as observed in the images) in multiple dimensions. For instance, a real-world object that exists in reality can be represented using a model that resembles or is an exact match of the real-world object. In one example, a model of a virtual vehicle representing a real vehicle located in a driveway may be presented by the display of an AR device (e.g., AR glasses, AR head-mounted display (HMD), or other device) while the user continues to view his or her natural surroundings through the display. The viewer may be able to manipulate the model while viewing the real-world scene. In another example, an actual object sitting on a table may be identified and rendered with a model that has a different color or different physical attributes in the AR environment. In some cases, artificial virtual objects that do not exist in reality or computer-generated copies of actual objects or structures of the user's natural surroundings can also be added to the AR environment.

There is an increasing number of applications that use face data (e.g., for XR systems, for 3D graphics, for security, among others), leading to a large demand for systems with the ability to generate detailed 3D face models (as well as 3D models of other objects) in an efficient and high-quality manner. There also exists a large demand for generating 3D models of other types of objects, such as 3D models of vehicles (e.g., for autonomous driving systems), 3D models of room layouts (e.g., for XR applications, for navigation by devices, robots, etc.), among others. Generating a detailed 3D model of an object (e.g., a 3D face model) typically requires expensive equipment and multiple cameras in an environment with controlled lighting, which hinders large-scale data collection.

Performing 3D object reconstruction (e.g., to generate a 3D model of an object, such as a face model) from one or more images can be challenging. Using a face as an illustrative example of a 3D object, 3D face reconstruction can be difficult based on the need to reconstruct the face geometry (e.g., shape) and the facial expression. In addition, it can be difficult to accurately reconstruct facial expressions for portions of the face that can experience high variations in appearance. In one illustrative example, the eyes of a face can be moved to extreme gaze directions (e.g., looking for to one side, crossing eyes, or the like). In another illustrative example, the upper and lower lips of the mouth of a face are controlled by muscles that allow a large variety of difficult to reconstruct mouth shapes (e.g., smiling, frowning, baring teeth, twisting lips, etc.).

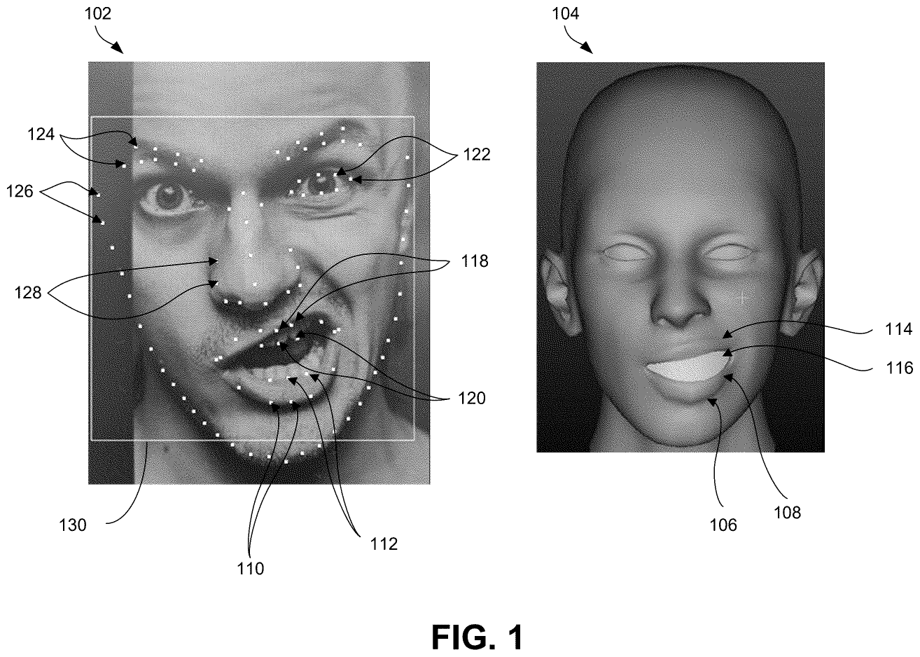

As illustrated in FIG. 1, white dots overlaid on a 2D facial image 102 can represent a projection of 3D vertices of a 3D facial model 104 back onto the original 2D facial image 102 used to generate the 3D facial model 104. For instance, in the illustration of FIG. 1, points corresponding to 3D vertices of major features of the 3D facial model (which can be referred to as landmarks or 2D landmarks) are depicted as white dots. As shown, landmarks 110, 112, 118, 120, 122, 124, 126, 128 are included for the outlines of lips, nose, mouth, eyes, eyebrows, nose, among others. Although the 3D facial model 104 may contain a much larger number of vertices, for purposes of illustration, only a small number of projected 3D vertices corresponding to the above listed facial features are shown. In the illustrated example of FIG. 1, landmarks corresponding to the inner contour 108 of the lower lip of the 3D facial model 104 projected onto a 2D image can include landmarks 112. Similarly, the landmarks corresponding to the outer contour 106 of the lower lip of the 3D facial model 104 can include landmarks 110.

FIG. 1 also illustrates the outer contour 114 and inner contour 116 of the upper lip of the 3D facial model 104. In some examples, landmarks corresponding to the outer contour 114 of the upper lip can include landmarks 118 and 124 and landmarks corresponding to the inner contour 116 of the upper lip can include landmarks 120. Additional landmarks projected from the 3D facial model 104 can include landmarks 122 corresponding to the left eye, landmarks 124 corresponding to the right eyebrow, landmarks 126 corresponding to the overall face outline, and landmarks 128 corresponding to the nose. As noted above, each of the landmarks (e.g., of the outer contour 114, the inner contour 116, landmarks 120, landmarks 122, landmarks 124, landmarks 126, and landmarks 128) can result from a projection of the 3D facial model 104 onto the 2D facial image 102.

FIG. 1 illustrates a two-dimensional (2D) facial image 102 and a corresponding 3D facial model 104 generated from the 2D facial image 102 using a parametric model, such as a 3D morphable model (3DMM). A parametric model (e.g., parametric mesh model) may be a 3D mesh model that is created using parameters which define aspects of the model, for example, rather than using a set of directly defined points. In some aspects, the 3D facial model 104 can include a representation of a facial expression in the 2D facial image 102. In one illustrative example, the facial expression representation can be formed from blendshapes. A blendshape can correspond to an approximate semantic parametrization of all or a portion of a facial expression, and a blendshape can semantically represent movement of muscles or portions of facial features (e.g., opening/closing of the jaw, raising/lowering of an eyebrow, opening/closing eyes, etc.). For example, a blendshape can correspond to a complete facial expression, or correspond to a “partial” (e.g., “delta”) facial expression. Examples of partial expressions include raising one eyebrow, closing one eye, moving one side of the face, etc. In one example, an individual blendshape can approximate a linearized effect of the movement of an individual facial muscle. In some cases, the semantic representation can be modeled to correspond with movements of one or more facial muscles. In some cases, each blendshape can be represented by a blendshape coefficient paired with a corresponding blendshape vector.

In some examples, the 3D facial model 104 can include a representation of the facial shape in the 2D facial image 102. In some cases, the facial shape can be represented by a facial shape coefficient paired with a corresponding facial shape vector. In some implementations a 3D model engine (e.g., a machine learning model) can be trained (e.g., during a training process) to enforce a consistent facial shape (e.g., consistent facial shape coefficients) for a 3D facial model regardless of a pose (e.g., pitch, yaw, and roll) associated with the 3D facial model. For example, when the 3D facial model is rendered into a 2D image for display, the 3D facial model can be projected onto a 2D image using a projection technique. While a 3D model engine that enforces a consistent facial shape independent of pose, the projected 2D image may have varying degrees of accuracy based on the pose of the 3D facial model captured in the projected 2D image.

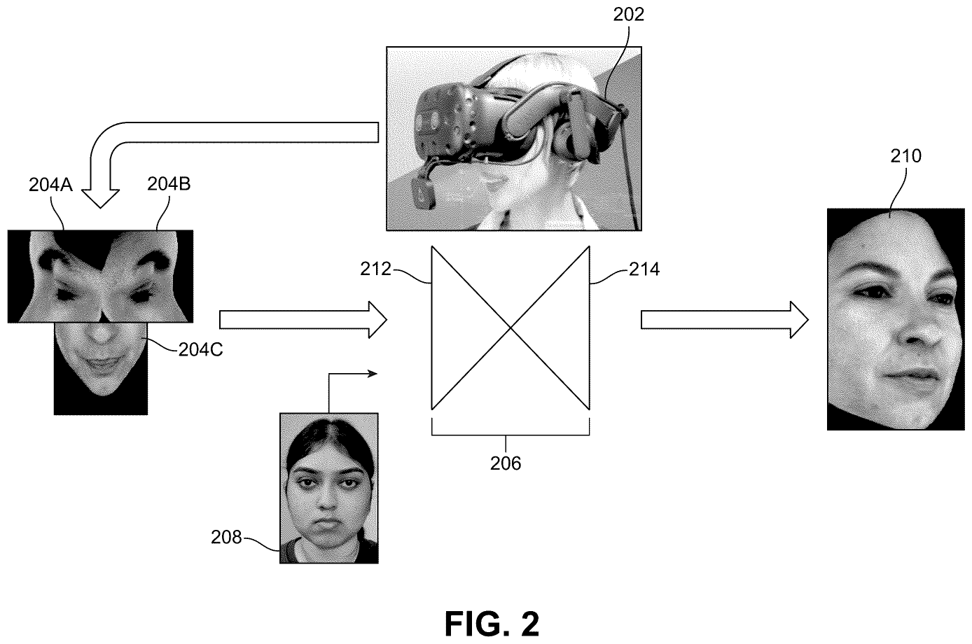

As shown in FIG. 2, a 3D modeling system 206 can utilize input frames such as oblique frames 204A, 204B, 204C, and/or 208 to generate the 3D facial model 210. In some cases, the 3D modeling system 206 may include an encoder 212 and a decoder 214. The encoder 212 may accept input, such as frames 204A, 204B, 204C, and/or 208 and generate a a latent vector (also referred to herein as a set of coefficients) that represents the input frames. The latent vector/set of coefficients may be input to the decoder 214 and the decoder 214 may generate a 3D mesh model (3DMM) that can be used to represent the geometry of the user's head. As shown in FIG. 2, the 3D modeling system 206 can also generate and/or apply a texture to the underlying 3DMM (e.g., the 3D facial model 104 of FIG. 1) to provide a digital representation of the user wearing the head mounted XR system 202.

However, in some cases, the resulting 3D facial model 210 can produce unrealistic results. For example, where the 3D modeling system 206 is trained on training images, there may be cross talk (e.g., unwanted correlations) between the facial regions. For example, a mouth region of a human face may move independently of the eyes of the human face (e.g., where a person's smile doesn't reach their eyes). However, some training sets may not have such diversity of data and a training set may include images where there is a correlation between, for example, movement of one portion of a face and another portion of the face, such as the mouth and eyes. In cases where a ML model of the 3D modeling system 206 is trained to generate the 3DMM using a plurality of images that each contain a different view of a face (e.g., with different views of the facial regions, such as the eyes, nose, and mouth, that are used to generate a 3DMM) together, there may be cross talk between the facial regions. Thus, the ML model may learn a correlation between a movement of a mouth and the eyes, such that the eyes of the 3DMM close a bit when the mouth expresses a smile, even if the user's eyes remain open the same amount.

Systems, apparatuses, processes (or methods), and computer-readable media (collectively referred to as “systems and techniques”) are described herein for a disentangled machine learning (ML) network architecture for accurate representation of facial avatars. In some examples, as described in more detail below, the systems and techniques can obtain a plurality of frames and generate, based on the plurality of frames, a 3DMM using a ML model. The ML model is trained using a training ML model that is trained to generate a training 3DMM. The ML model may generate information for a first portion of the 3DMM, such as a right-eye region, left-eye region, mouth regions, etc., corresponding to a first portion of the face and a second portion of the 3DMM corresponding to a second portion of the face. The portions may be generated independently.

In some cases, the information for the first portion of the 3DMM may be a first mesh model of the first portion of the 3DMM, and the information for the second portion of the 3DMM may be a second mesh model of the second portion of the 3DMM. This first mesh model and the second mesh model may be generated independently, for example, such as by two separate view specific ML models. In some cases, the view specific ML models are trained based on a comparison between the 3DMM and the training 3DMM.

In some cases, the information for the first portion of the 3DMM may be a first set of coefficients for generating a mesh model of the first portion of the 3DMM and the information for the second portion of the 3DMM may be a second set of coefficients for generating a mesh model of the second portion of the 3DMM. The first set of coefficients may be generated by a first view specific ML model and the second set of coefficients may be generated a second view specific ML model and the first set of coefficients and second set of coefficients may be merged to generate the 3DMM. In some cases, the view specific ML models are trained based on a comparison between the 3DMM and the training 3DMM.

Various aspects of the techniques described herein will be discussed below with respect to the figures.

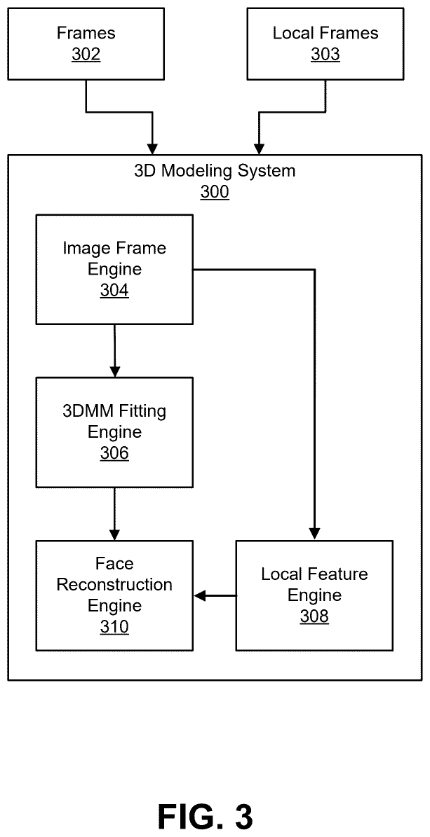

FIG. 3 is a diagram illustrating an example of a 3D modeling system 300 that can generate a 3D model (e.g., a 3D morphable model (3DMM)) using at least one image frame 302. The 3D modeling system 300 also obtains local frames (e.g., frames from a user facing camera of the head mounted XR system 202 of FIG. 2). As shown in FIG. 3, the 3D modeling system 300 includes an image frame engine 304, a 3D model fitting engine 306, and a face reconstruction engine 310. While the 3D modeling system 300 is shown to include certain components, one of ordinary skill will appreciate that the 3D modeling system 300 can include more components than those shown in FIG. 3. The components of the 3D modeling system 300 can include software, hardware, or one or more combinations of software and hardware. For example, in some implementations, the components of the 3D modeling system 300 can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the 3D modeling system 300.

The image frame engine 304 can obtain or receive an image frame 302 and/or local frames 303 captured by an image sensor, from storage, from memory, from an external source (e.g., a server, an external memory accessed via a network, or other external source), or the like. In some cases, the image frame can be included in a sequence of frames (e.g., a video, a sequence of standalone or still images, etc.). In one illustrative example, each frame of the sequence of frames can include a grayscale component per pixel. Other examples of frames include frames having red (R), green (G), and blue (B) components per pixel (referred to as an RGB video including RGB frames), luma, chroma-blue, chroma-red (YUV, YCbCr, or Y′CbCr) components per pixel and/or any other suitable type of image. The sequence of frames can be captured by one or more cameras, obtained from storage, received from another device (e.g., a camera or device including a camera), or obtained from another source. In some implementations, the image frame engine 304 can convert the image frame 302 to grayscale. The image frame engine 304 can, in some cases, crop a portion of the image frame 302 that corresponds to a face. In some examples, the image frame engine 304 can perform a face detection process and/or face recognition process to detect and/recognize a face within the image frame 302. The image frame engine 304 can generate or apply a bounding box (e.g., bounding box 130 shown in FIG. 1) around the face and can crop out the image data within the bounding box to generate an input image for the 3D model fitting engine 306.

The 3D model fitting engine 306 can receive an input image (e.g., the image frame 302, the cropped bounding box around the face in the image frame 302, etc.) from the image frame engine 304. The 3D model fitting engine 306 may include an encoder and may use the input images to generate coefficients, such as shape coefficients and/or blendshape coefficients that represent the shape and/or expression of a face. Using the input image, the 3D model fitting engine 306 can perform a 3D model fitting technique to generate a 3D model (e.g., a 3DMM model) of the face (which can include the head of the person in the image frame 302). The 3D model fitting technique can include solving for shape coefficients αᵢ and expression coefficients bⱼ. In some examples, the 3D model fitting can include solving for positional information related to the object. In the example of the object being a head of a person, the positional information may include pose information related to a pose of the head. For example, the pose information may indicate an angular rotation of the head with respect to a neutral position of the head. The rotation may be along a first axis (e.g., a yaw axis), a second axis (e.g., a pitch axis), and/or a third axis (e.g., a roll axis). In some cases, the 3D model fitting can also include a focal length for projection of the 3D model onto a 2D image using any suitable projection technique. In some examples, a weak perspective model can use the focal length produced by the 3D model fitting engine 306 to project the 3D vertices of the 3D model (e.g., the 3DMM) onto a 2D image. In some examples, a full perspective model can use the focal length produced by the 3D model fitting engine 306 to project the 3D vertices of the 3D model (e.g., the 3DMM) onto a 2D image. In some cases, the 3D model fitting engine 306 may be implemented using one or more machine learning (ML) models.

The local feature engine 308 can receive one or more input frames (e.g., local frames 303) from the image frame engine 304. In some implementations, the local feature engine 308, can be implemented using one or more machine learning (ML) models (e.g., a deep learning neural network). In some examples, the machine learning model can be trained to generate local textures for portions of the face such as the eyes and the mouth that can be combined with a full facial texture for the 3DMM generated by the 3D model fitting engine 306. In one example, the local frames 303 can include oblique frames 204A, 204B, 204C captured by user facing cameras on a head mounted XR system as illustrated in FIG. 2.

The face reconstruction engine 310 can receive the coefficients generated by the 3D model fitting engine 306 to generate the 3D model (e.g., the 3DMM). The 3D model can be generated or constructed as a linear combination of a mean face (sometimes referred to as a neutral face), facial shape basis vectors, and facial expression basis vectors. The mean face can represent an average face that can be transformed (e.g., by the shape basis vectors and expression basis vectors) to achieve the desired final 3D face shape of the 3D model. The facial shape basis vectors can be used to scale proportions of the mean face. In some cases, the facial shape basis vectors may be used to represent a fat or thin face, a small or large nose, and any adjustment to the basic facial shape. In some implementations, the facial shape basis vectors are determined based on principal component analysis (PCA). In some cases, the facial expression basis vectors can represent facial expressions, such as smiling, lifting an eyebrow, blinking, winking, frowning, etc. In some cases, the face reconstruction engine 310 may be implemented using one or more ML models.

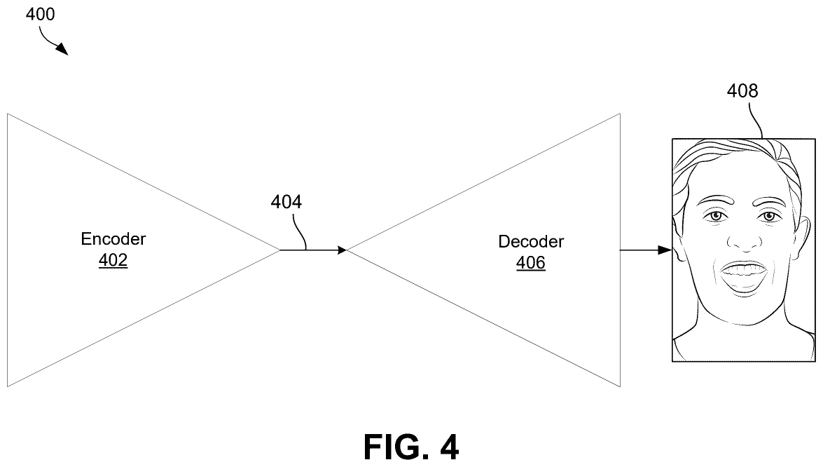

FIG. 4 is a block diagram illustrating a ML model 400 for generating facial avatars, in accordance with aspects of the present disclosure. In some cases, an encoder 402, such as one of a 3DMM fitting engine (e.g., 3D model fitting engine 306 of FIG. 3) may generate (e.g., encode) a representation of a 3DMM based on one or more images, for example, of a user of a device. In some case, such as during training, synthetic images may be used. A synthetic image may be an image generated in one domain, such as a color image, that may be converted into another domain, such as infrared or near infrared. Synthetic images may also include images generated from a model of a person, such as a 3DMM of a person. The representation of the 3DMM may be passed 404 to a decoder 406. The decoder 406 may use the representation of the 3DMM to generate a 3D representation of the face, such as a 3DMM 408, for the avatar.

In some cases, a ML model, such as ML model 400, trained to reconstruct a 3DMM from partial face images (e.g., oblique frames 204 of FIG. 2) using synthetic data may perform less than optimally when used with real-world data. For example, aggregating the partial face images to train the ML model in one shot (e.g., with views of the eyes, nose, and mouth together) may result in cross talk (e.g., unwanted correlations) between the facial regions. As an example, the ML model may learn a correlation between a movement of a mouth and the eyes, such that the eyes of the 3DMM close a bit when the mouth expresses a smile, even if the user's eyes remain open the same amount. In some cases, a disentangled ML architecture capable of disentangle the information from different cameras to predict corresponding 3DMM coefficients for different facial regions may be useful.

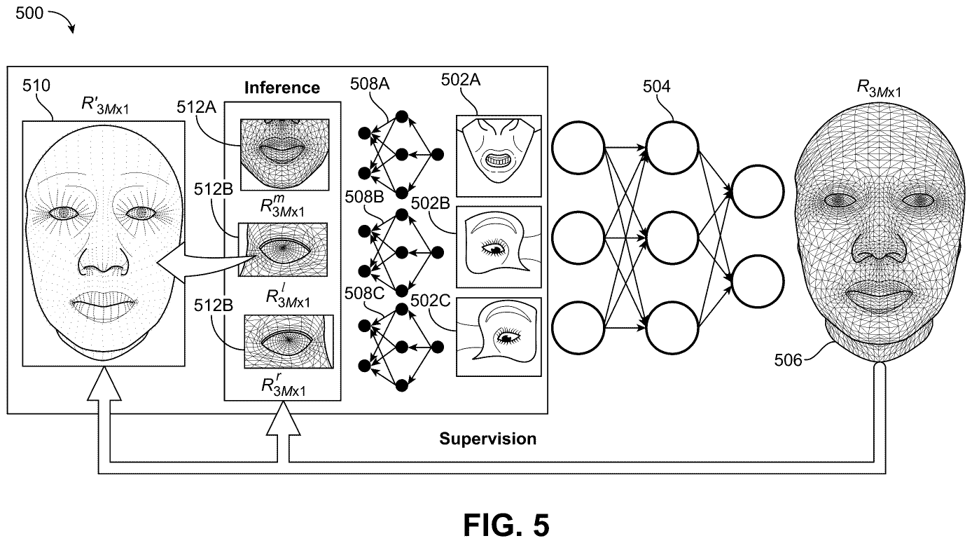

FIG. 5 illustrates an architecture for training a disentangled ML network architecture 500, in accordance with aspects of the present disclosure. The disentangled ML network architecture may include two stages. In a first stage, images 502A, 502B, 502C (collectively, a set of images 502) may be received and input to a training ML model 504 to generate a training 3DMM 506. The set of images 502 may be a set of images captured by an XR device of the user of the XR device that may be used for generating an avatar for the user. In some cases, the set of images 502 may be infrared/near infrared images. During training, images, of the set of images 502, may be synthetic images (e.g., synthetic near infrared images generated from RGB images).

In some cases, the training ML model 504 may be substantially similar to ML model 400 of FIG. 4. The training ML model 504 may be any ML model that may be trained to generate a 3DMM based on input images, and examples of ML models that may be used may include RESNET, transformer network, MLP, CNN, etc. Of note, the training ML model 504 may generate entangled data and the training ML model 504 may exhibit entanglement issues, such as where certain expressions of the mouth may influence how the eyes move. In some cases, these entanglement issues may arise due to the training data including, for example, images of a relatively large number of people who narrow their eyes when they smile. In some cases, the training ML model 504 may receive the set of images 502 as input (e.g., multiple images of the user of an XR system), the training ML model 504 may generate the training 3DMM 506 using all of the images in the set of images 502 resulting in inadvertently entangling, for example, movement of the eyes when the mouth moves in a certain way.

To avoid such entanglement, a second training stage may be implemented. In this second stage, the weights of the training ML model 504 may be frozen. Images of the set of images 502 may then be passed into view specific ML models 508A, 508B, 508C (collectively, view specific ML models 508) to generate information that may be used to generate an overall 3DMM 510. For example, the view specific ML models 508 may generate meshes for portions of the overall 3DMM 510 that are visible in a specific view. For example, image 502A may be view of a mouth of a person and image 502A may be passed to a first view specific ML model 508A that may generate a mesh model of a mouth portion.

The first view specific ML model 508A may generate a first portion 512A of a mesh model corresponding to a mouth (e.g., mouth portion) visible in image 502A. Similarly, a second view specific ML model 508B may generate a second portion 512B (e.g., mesh) of a mesh model corresponding to a right eye and area around the right eye (e.g., right-eye portion) and so forth for the images of the set of images 502. The portions (e.g., 512A, 512B, 512C, collectively portions 512, portions of mesh, mesh, etc.) of the of the mesh model may then be merged into the overall 3DMM 510. In some cases, merging (e.g., stitching) may be performed by a ML model, which may be trained to determine how the vertices of the portions 512 may overlap and fit together. In some cases, the ML model for merging the portions 512 may be trained based on a comparison between the overall 3DMM 510 and the training 3DMM 506.

In some cases, a view specific ML model may be used per region of a face and the view specific ML models may operate independently (e.g., as separate ML models). In some cases, a view specific ML model may receive, as input, multiple images. For example, if multiple images are captured of the right eye, a view specific ML model for generating the portion of the mesh model of the area around the right eye may use the multiple images to generate a portion of the mesh model around the right eye.

The view specific ML models 508 may be trained based on the training 3DMM 506. In some cases, a loss for training the view specific ML models 508 may be determined by comparing the portions 512 of the mesh model to corresponding portions of the training 3DMM 506. For example, the first portion 512A of the mesh model may be compared to a corresponding area around the mouth of the training 3DMM 506 to determine a first loss for training the first view specific ML model 508A. Similarly, the second portion 512B of a mesh model may be compared to a corresponding area around the right eye of the training 3DMM 506 to determine a second loss for training the second view specific ML model 508B, and so forth for each portion of the mesh model. In some cases, a loss may also be determined between the overall 3DMM 510 and the training 3DMM 506.

In some cases, while the training ML model 504 and the training 3DMM 506 may exhibit entanglement of expressions between different potions of the face when used with real-world data, using the training ML model 504 and the training 3DMM 506 to train the view specific ML models 508 may not result in entanglement of expressions between different potions of the face. For example, the entanglement of expressions may not be apparent for the training ML model 504 with the training data as the entanglement may arise, in part, due to quirks of the training data (e.g., as images of the training data include a relatively large number of people who narrow their eyes when they smile). As the individual view specific ML models 508 are trained independently using a specific view of a portion of the face (e.g., mouth region, region around a specific eye, etc.) the view specific ML models 508 may have reduced cross talk between the facial regions and may not learn unwanted correlations between the facial regions that the training ML model 504 may have learned when trained on the set of images 502.

In some cases, the technique for training the disentangled ML network architecture 500 can be described such that Iₗ, Iᵣ, and lₘ (e.g., set of images 502) represent images of left-eye, right-eye and mouth, respectively, from an XR headset, let E denote, for example, a regular ResNet-based architecture which is susceptible to expression entanglement problem (e.g., training ML model 504), and let C_{N×1} denote an output of E, which contains all the parameters affecting the facial expressions of the rendered avatar, such that E(lₗ, lᵣ, lₘ)=C_{N×1}. A final avatar with M vertices may be reconstructed based on E using a fixed decoder D such that D_{3M×N}·C_{N×1}=R_{3M×1}, where R_{3M×1} represents a reconstructed 3DMM (e.g., training 3DMM 506) for generating the avatar. In some cases, as the facial parameters in C are determined based on all the input images lₗ, lᵣ, lₘ, R may be subject to the entanglement issues.

To address this entanglement issue, view specific ML models Zₗ, Zᵣ, Zₘ (e.g., view specific ML models 508) may be defined. The view specific ML models Zₗ, Zᵣ, Zₘ may encode the facial parameters cₗ, cᵣ, cₘ belonging to left-eye, right-eye, and mouth, respectively, for a 3DMM such that

$${Z}_{l} ( {I}_{l} ) = {C}_{N \times 1}^{1} , {Z}_{r} ( {l}_{r} ) = {C}_{N \times 1}^{2} , and {Z}_{m} ( {I}_{m} ) = {C}_{N \times 1}^{3} .$$

The view specific ML models Zₗ, Zᵣ, Zₘ may generate region specific meshes

$${R}_{3 M \times 1}^{l} , {R}_{3 M \times 1}^{r} , {R}_{3 M \times 1}^{m}$$

(e.g., portions 512 of the mesh model) for the left-eye region, right-eye region, and mouth region respectively, using 3 separate decoders such that

$${D}_{3 M \times N} \cdot {C}_{N \times 1}^{1} = {R}_{3 M \times 1}^{l} , {D}_{3 M \times N} \cdot {C}_{N \times 1}^{2} = {R}_{3 M \times 1}^{r} , and$$

$${D}_{3 M \times N} \cdot {C}_{N \times 1}^{3} = {R}_{3 M \times 1}^{m} .$$

The region specific meshes may be fused into a single mesh R′_{3M×1}. (e.g., overall 3DMM 510) using Z_{stitch}, such that

$${R}_{3 M \times 1}^{′} = {Z}_{stitch} ( {R}_{3 M \times 1}^{l} , {R}_{3 M \times 1}^{r} , {R}_{3 M \times 1}^{m} ) .$$

In some cases, Zₗ, Zᵣ, Zₘ, Z_{stitch} may all be trained with supervision from R_{3M×1}. In some cases, the training 3DMM 506 R_{3M×1} may be used for training and not during inference.

In some cases, stitching issues may arise when performing disentanglement in the mesh space. Whether stitching issues arise may be dependent, at least in part, on the training data and/or positioning of the cameras for capturing images of the user. In such cases, it can be useful to disentangle in a parameter space instead of the mesh space. For example, as indicated above, the ML model, such as the training ML model 504 may include an encoder and decoder (e.g., encoder 402 and decoder 406 of FIG. 4). The encoder may generate a full set of coefficients that may be passed to the decoder to generate the 3DMM. In some cases, coefficients of the full set of coefficients may describe how different portions of the face may appear. For example, coefficients 218, 145, 58, . . . may describe the left eye region, coefficients 293, 215, 193, . . . describe the right eye region, and coefficients 182, 152, 200, . . . describe the mouth region.

The coefficients corresponding to the different regions of the face may be identified. For example, coefficients pertaining to the left eye region may be identified as a first set of coefficients c_{l×1}, coefficients pertaining to the right eye region may be identified as a second set of coefficients c_{r×1} and coefficients pertaining to the mouth region may be identified as a third set of coefficients c_{m×1}, such that the output of the encoder E, C_{N×1} can be represented as

$${C}_{N \times 1} = [ \begin{matrix}{c}_{l \times 1} \\ {c}_{r \times 1} \\ {c}_{m \times 1}\end{matrix} ] .$$

The view specific ML models 508 may then be trained to generate those coefficients (e.g., as portions of the parametric model) corresponding to a specific region. For example, the view specific ML model Zₗ may generate the first set of coefficients c_{l×1} for the left-eye region, the view specific ML model Zᵣ may generate the second set of coefficients c_{r×1} for the right eye-region, and view specific ML model Zₘ may generate the third set of coefficients c_{l×1} for the mouth region. After the sets of coefficients for the specific regions are generated, the coefficients may be merged by copying the coefficients for the specific regions into the appropriate locations for the full set of coefficients. In some cases, certain coefficients (e.g., coefficients not included in the regions) of the full set of coefficients may not be a part of the coefficients corresponding to a specific region and these coefficients not included in the regions may be used to generate portions of the 3DMM not included in the specific regions. The coefficients not included in the regions may be generated separately by another ML model and merged with the coefficients for the specific regions to generate the full set of coefficients.

The full set of coefficients may be passed into the decoder to generate the overall 3DMM 510. In some cases, a single decoder may be used, rather than region specific decoders. The overall 3DMM 510 may then be compared to the training 3DMM 506 to generate a loss as described above. As the coefficients are merged in parameter space, rather than merging the region specific meshes, boundary artifacts should not be present.

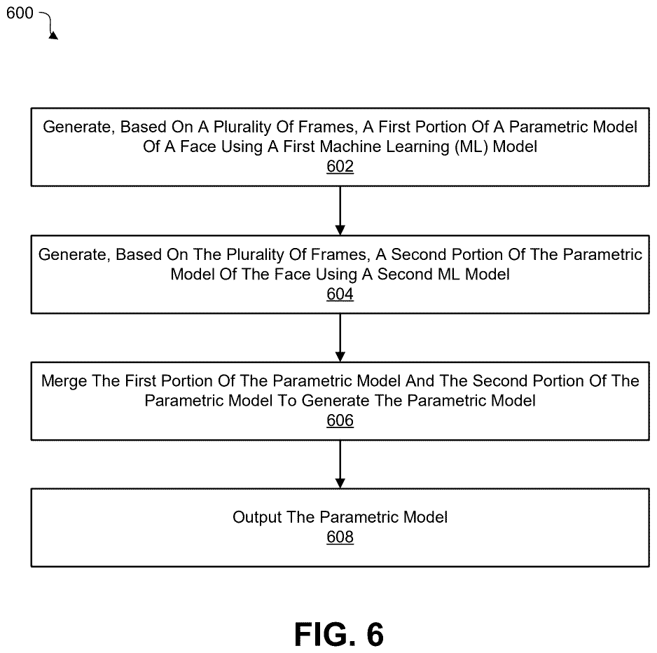

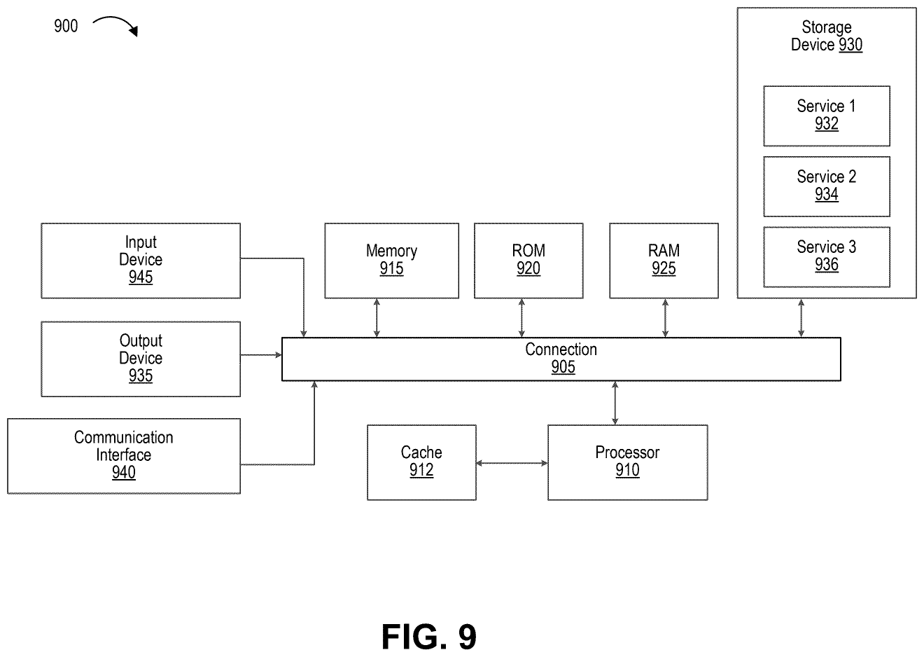

FIG. 6 illustrates a flowchart of a process 600 for generating a mesh model, in accordance with aspects of the present disclosure. The process 600 may be performed by a computing device (or apparatus) or a component (e.g., 3D modeling system 206 of FIG. 2, encoder 212 of FIG. 2, decoder 214 of FIG. 2, 3D modeling system 300 of FIG. 3, 3D model fitting engine 306 of FIG. 3, face reconstruction engine 310 of FIG. 3, training ML model 504 of FIG. 5, view specific ML models 508 of FIG. 5, processor 910 of FIG. 9, etc.) of the computing device. Examples of the computing device can include the head mounted XR system 202 of FIG. 2, computing system 900 of FIG. 9. The computing device may also be a mobile device (e.g., a mobile phone), an extended reality (XR) device such as a virtual reality (VR) device or augmented reality (AR) device, a vehicle or component or system of a vehicle, a network-connected wearable such as a watch, or other type of computing device. In another example, the process 600 may be performed by a computing device with the computing system 900 shown in FIG. 9. The operations of the process 600 may be implemented as software components that are executed and run on one or more processors.

At block 602, the computing device (or component thereof) may generate, based on a plurality of frames, a first portion of a parametric model of a face using a first machine learning (ML) model. In some cases, each frame includes a portion of a face. In some cases, the first ML model is configured to generate information for a first portion (e.g., of portions 512 of FIG. 5) of the parametric model corresponding to a first portion of the face. In some cases, the parametric model comprises a 3D mesh model (3DMM).

At block 604, the computing device (or component thereof) may generate, based on the plurality of frames, a second portion of the parametric model (e.g., 3DMM 510 of FIG. 5) of the face using a second ML model. In some examples, the first portion of the first portion of the parametric model is generated independently from the second portion of the parametric model. In some examples, the first portion of the parametric model is generated independently from the second portion of the parametric model. The second portion of the parametric model corresponding to a second portion of the face (and in some cases additional portions of the parametric model corresponding to portions of the face, such as a third portion, fourth portion, etc., may also be generated). In some examples, the first portion of the 3DMM comprises a first mesh model of the first portion of the 3DMM. In some cases, the second portion of the 3DMM comprises a second mesh model of the second portion of the 3DMM. In some examples, the computing device (or component thereof) may generate the first mesh model of the first portion of the 3DMM and generate the second mesh model of the second portion of the 3DMM, where the first mesh model of the first portion of the 3DMM is generated independently from the second mesh model of the second portion of the 3DMM. In some cases, the first ML model comprises a first view specific ML model (e.g., view specific ML models 508 of FIG. 5), and the second ML model comprises a second view specific ML model. In some examples, the computing device (or component thereof) may generate a training 3DMM using a third ML model (e.g., training ML model 504 of FIG. 5), and the first view specific ML model and second view specific ML model are trained based on a comparison of the 3DMM and the training 3DMM (e.g., training 3DMM 506 of FIG. 5) generated by the third ML model.

At block 606, the computing device (or component thereof) may generate, based on the plurality of frames, a second portion of the parametric model of the face using a second ML model, wherein the first portion of the parametric model is generated independently from the second portion of the parametric model. In some cases, the computing device (or component thereof) may merge a first mesh of the first portion of the parametric model and a second mesh of the second portion of the parametric model to generate the parametric model. In some examples, the first portion of the parametric model comprises a first set of coefficients for generating a mesh model of the first portion of the parametric model, and the second portion of the parametric model comprises a second set of coefficients for generating a mesh model of the second portion of the parametric model. In some cases, the first set of coefficients are generated by a first view specific ML model, and the second set of coefficients are generated by a second view specific ML model. In some examples, the first ML model and second ML model are trained using a third ML model, and the ML model and second ML model are trained based on a comparison of the parametric model and a training parametric model (e.g., training 3DMM 506 of FIG. 5) generated by the third ML model(e.g., training ML model 504 of FIG. 5). In some cases, the computing device (or component thereof) may merge the first set of coefficients and the second set of coefficients for generating the parametric model.

At block 608, the computing device (or component thereof) may output the parametric model.

In other examples, a device may include an application or function to perform some of the processes described herein (e.g., process 600 and/or any other process described herein). In some examples, the processes described herein (e.g., process 600 and/or any other process described herein) may be performed by a computing device or apparatus. In some examples, the process 600 can be performed by the 3D modeling system 300. In another example, process 600 can be performed by a computing device or system with the architecture of the computing system 900 shown in FIG. 9.

The computing device can include any suitable device, such as a mobile device (e.g., a mobile phone), a desktop computing device, a tablet computing device, an extended reality (XR) device or system (e.g., a VR headset, an AR headset, AR glasses, or other XR device or system), a wearable device (e.g., a network-connected watch or smartwatch, or other wearable device), a server computer or system, a vehicle or computing device of a vehicle (e.g., an autonomous vehicle), a robotic device, a television, and/or any other computing device with the resource capabilities to perform the processes described herein, including the process 600.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 600 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 600 and/or other processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

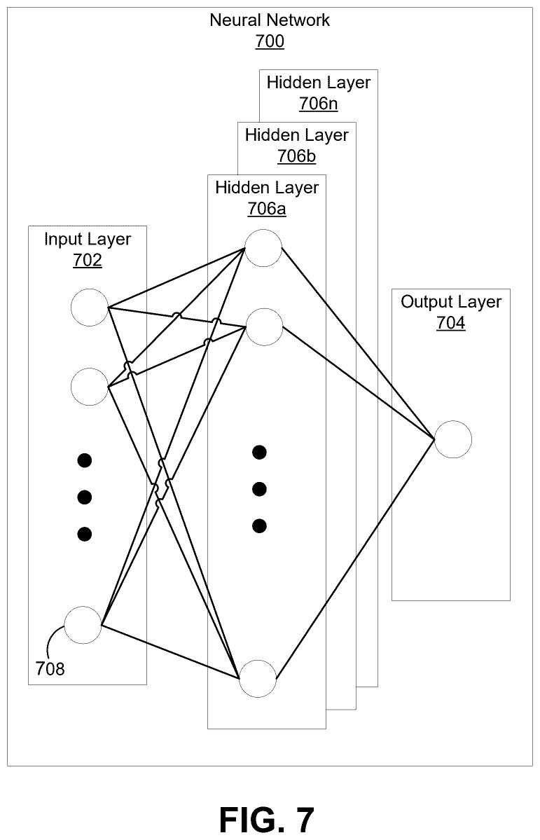

FIG. 7 is an illustrative example of a deep learning neural network 700 that can be used by a 3D model training system. An input layer 702 includes input data. In one illustrative example, the input layer 702 can include data representing the pixels of an input video frame. The neural network 700 includes multiple hidden layers 706a, 706b, through 706n. The hidden layers 706a, 706b, through 706n include “n” number of hidden layers, where “n” is an integer greater than or equal to one. The number of hidden layers can be made to include as many layers as needed for the given application. The neural network 700 further includes an output layer 704 that provides an output resulting from the processing performed by the hidden layers 706a, 706b, through 706n. In one illustrative example, the output layer 704 can provide a classification for an object in an input video frame. The classification can include a class identifying the type of object (e.g., a person, a dog, a cat, or other object).

The neural network 700 is a multi-layer neural network of interconnected nodes. Each node can represent a piece of information. Information associated with the nodes is shared among the different layers and each layer retains information as information is processed. In some cases, the neural network 700 can include a feed-forward network, in which case there are no feedback connections where outputs of the network are fed back into itself. In some cases, the neural network 700 can include a recurrent neural network, which can have loops that allow information to be carried across nodes while reading in input.

Information can be exchanged between nodes through node-to-node interconnections between the various layers. Nodes of the input layer 702 can activate a set of nodes in the first hidden layer 722a. For example, as shown, each of the input nodes of the input layer 702 is connected to each of the nodes of the first hidden layer 722a. The nodes of the hidden layers 706a, 706b, through 062n can transform the information of each input node by applying activation functions to the information. The information derived from the transformation can then be passed to and can activate the nodes of the next hidden layer 706b, which can perform their own designated functions. Example functions include convolutional, up-sampling, data transformation, and/or any other suitable functions. The output of the hidden layer 706b can then activate nodes of the next hidden layer, and so on. The output of the last hidden layer 722n can activate one or more nodes of the output layer 704, at which an output is provided. In some cases, while nodes (e.g., node 708) in the neural network 700 are shown as having multiple output lines, a node has a single output and all lines shown as being output from a node represent the same output value.

In some cases, each node or interconnection between nodes can have a weight that is a set of parameters derived from the training of the neural network 700. Once the neural network 700 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 700 to be adaptive to inputs and able to learn as more and more data is processed.

The neural network 700 is pre-trained to process the features from the data in the input layer 702 using the different hidden layers 706a, 706b, through 706n in order to provide the output through the output layer 704. In an example in which the neural network 700 is used to identify objects in images, the neural network 700 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the neural network 700 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 700 is trained well enough so that the weights of the layers are accurately tuned.

For the example of identifying objects in images, the forward pass can include passing a training image through the neural network 700. The weights are initially randomized before the neural network 700 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 700, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 700 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times the actual answer minus the predicted (output) answer squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 700 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{d W} ,$$

where w denotes a weight, wi denotes the initial weight, and f denotes a learning rate. The learning rate can be set to any suitable value, with a high learning rate including larger weight updates and a lower value indicating smaller weight updates.

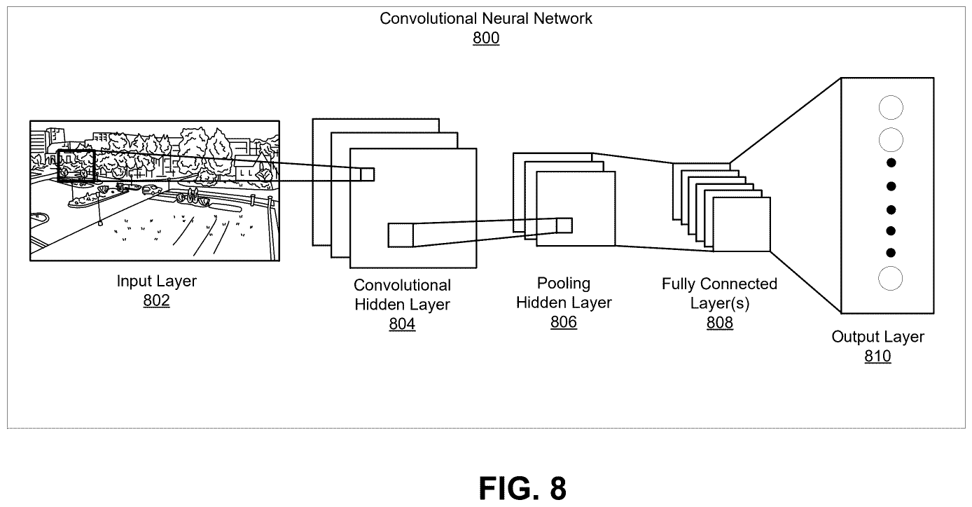

The neural network 700 can include any suitable deep network. One example includes a convolutional neural network (CNN), which includes an input layer and an output layer, with multiple hidden layers between the input and out layers. An example of a CNN is described below with respect to FIG. 8. The hidden layers of a CNN include a series of convolutional, nonlinear, pooling (for downsampling), and fully connected layers. The neural network 700 can include any other deep network other than a CNN, such as an autoencoder, a deep belief nets (DBNs), a Recurrent Neural Networks (RNNs), among others.

FIG. 8 is an illustrative example of a convolutional neural network (CNN 800). The input layer 802 of the CNN 800 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 804, an optional non-linear activation layer, a pooling hidden layer 806, and fully connected layers 808 to get an output at the output layer 810. While only one of each hidden layer is shown in FIG. 8, one of ordinary skill will appreciate that multiple convolutional hidden layers, non-linear layers, pooling hidden layers, and/or fully connected layers can be included in the CNN 800. As previously described, the output can indicate a single class of an object or can include a probability of classes that best describe the object in the image.

The first layer of the CNN 800 is the convolutional hidden layer 804. The convolutional hidden layer 804 analyzes the image data of the input layer 802. Each node of the convolutional hidden layer 804 is connected to a region of nodes (pixels) of the input image called a receptive field. The convolutional hidden layer 804 can be considered as one or more filters (each filter corresponding to a different activation or feature map), with each convolutional iteration of a filter being a node or neuron of the convolutional hidden layer 804. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 804. Each connection between a node and a receptive field for that node learns a weight and, in some cases, an overall bias such that each node learns to analyze its particular local receptive field in the input image. Each node of the convolutional hidden layer 804 will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 804 is due to each node of the convolutional layer being applied to its corresponding receptive field. For example, a filter of the convolutional hidden layer 804 can begin in the top-left corner of the input image array and can convolve around the input image. As noted above, each convolutional iteration of the filter can be considered a node or neuron of the convolutional hidden layer 804. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 804.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 804.

The mapping from the input layer to the convolutional hidden layer 804 is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 804 can include several activation maps in order to identify multiple features in an image. The example shown in FIG. 8 includes three activation maps. Using three activation maps, the convolutional hidden layer 804 can detect three different kinds of features, with each feature being detectable across the entire image.

In some examples, a non-linear hidden layer can be applied after the convolutional hidden layer 804. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 800 without affecting the receptive fields of the convolutional hidden layer 804.

The pooling hidden layer 806 can be applied after the convolutional hidden layer 804 (and after the non-linear hidden layer when used). The pooling hidden layer 806 is used to simplify the information in the output from the convolutional hidden layer 804. For example, the pooling hidden layer 806 can take each activation map output from the convolutional hidden layer 804 and generates a condensed activation map (or feature map) using a pooling function. Max-pooling is one example of a function performed by a pooling hidden layer. Other forms of pooling functions be used by the pooling hidden layer 806, such as average pooling, L2-norm pooling, or other suitable pooling functions. A pooling function (e.g., a max-pooling filter, an L2-norm filter, or other suitable pooling filter) is applied to each activation map included in the convolutional hidden layer 804. In the example shown in FIG. 8, three pooling filters are used for the three activation maps in the convolutional hidden layer 804.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 804. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 804 having a dimension of 24×24 nodes, the output from the pooling hidden layer 806 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 800.

The final layer of connections in the network is a fully-connected layer that connects every node from the pooling hidden layer 806 to every one of the output nodes in the output layer 810. Using the example above, the input layer includes 28×28 nodes encoding the pixel intensities of the input image, the convolutional hidden layer 804 includes 3×24×24 hidden feature nodes based on application of a 5×5 local receptive field (for the filters) to three activation maps, and the pooling hidden layer 806 includes a layer of 3×12×12 hidden feature nodes based on application of max-pooling filter to 2×2 regions across each of the three feature maps. Extending this example, the output layer 810 can include ten output nodes. In such an example, every node of the 3×12×12 pooling hidden layer 806 is connected to every node of the output layer 810.

The fully connected layer 808 can obtain the output of the previous pooling hidden layer 806 (which should represent the activation maps of high-level features) and determines the features that most correlate to a particular class. For example, the fully connected layer 808 layer can determine the high-level features that most strongly correlate to a particular class, and can include weights (nodes) for the high-level features. A product can be computed between the weights of the fully connected layer 808 and the pooling hidden layer 806 to obtain probabilities for the different classes. For example, if the CNN 800 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 810 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 9 is a diagram illustrating an example of a system for implementing certain aspects of the present technology. In particular, FIG. 9 illustrates an example of computing system 900, which can be for example any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some aspects, computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 900 includes at least one processing unit (CPU or processor) 910 and connection 905 that couples various system components including system memory 915, such as read-only memory (ROM) 920 and random access memory (RAM) 925 to processor 910. Computing system 900 can include a cache 912 of high-speed memory connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some aspects, a hardware service that performs a particular function can include the software component stored in a computer-readable medium in connection with the necessary hardware components, such as processor 910, connection 905, output device 935, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, mobile phones (e.g., smartphones or other types of mobile phones), tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

### ILLUSTRATIVE ASPECTS OF THE DISCLOSURE INCLUDE

Aspect 1. An apparatus for generating a mesh model, comprising: at least one memory; and at least one processor coupled to the at least one memory, wherein the at least one processor is configured to: obtain a plurality of frames, wherein each frame includes a portion of a face; generate, based on the plurality of frames, a parametric model using a machine learning (ML) model, wherein the ML model is configured to generate information for a first portion of the parametric model corresponding to a first portion of the face, the first portion of the parametric model being independent from information for a second portion of the parametric model corresponding to a second portion of the face; and output the parametric model.

Aspect 2. The apparatus of Aspect 1, wherein the parametric model comprises a 3D mesh model (3DMM), wherein the information for the first portion of the 3DMM comprises a first mesh model of the first portion of the 3DMM, and wherein the information for the second portion of the 3DMM comprises a second mesh model of the second portion of the 3DMM.

Aspect 3. The apparatus of Aspect 2, wherein the at least one processor is configured to: generate the first mesh model of the first portion of the 3DMM; and generate the second mesh model of the second portion of the 3DMM, wherein the first mesh model of the second portion of the 3DMM is generated independently from the second mesh model of the first portion of the 3DMM.

Aspect 4. The apparatus of Aspect 3, wherein the at least one processor is configured to: generate the first mesh model using a first view specific ML model of the ML model; and generate the second mesh model using a second view specific ML model of the ML model.

Aspect 5. The apparatus of Aspect 4, wherein the ML model is trained using a training ML model, and wherein the first view specific ML model and second view specific ML model are trained based on a comparison of the 3DMM and a training 3DMM generated by the training ML model.

Aspect 6. The apparatus of any of Aspects 1-5, wherein the at least one processor is configured to merge a first mesh of the first portion of the parametric model and a second mesh of the second portion of the parametric model to generate the parametric model.

Aspect 7. The apparatus of any of Aspects 1-6, wherein the information for the first portion of the parametric model comprises a first set of coefficients for generating a mesh model of the first portion of the parametric model, and wherein the information for the second portion of the parametric model comprises a second set of coefficients for generating a mesh model of the second portion of the parametric model.

Aspect 8. The apparatus of Aspect 7, wherein the first set of coefficients are generated by a first view specific ML model of the ML model, and wherein the second set of coefficients are generated by a second view specific ML model of the ML model.

Aspect 9. The apparatus of Aspect 8, wherein the ML model is trained using a training ML model, and wherein the first view specific ML model and second view specific ML model are trained based on a comparison of the parametric model and a training parametric model generated by the training ML model.

Aspect 10. The apparatus of any of Aspects 7-9, wherein the at least one processor is configured to merge the first set of coefficients and the second set of coefficients for generating the parametric model.

Aspect 11. A method for generating a mesh model, comprising: obtaining a plurality of frames, wherein each frame includes a portion of a face; generating, based on the plurality of frames, a parametric model using a machine learning (ML) model, wherein the ML model is configured to generate information for a first portion of the parametric model corresponding to a first portion of the face, the first portion of the parametric model being independent from information for a second portion of the parametric model corresponding to a second portion of the face; and outputting the parametric model.

Aspect 12. The method of Aspect 11, wherein the parametric model comprises a 3D mesh model (3DMM), wherein the information for the first portion of the 3DMM comprises a first mesh model of the first portion of the 3DMM, and wherein the information for the second portion of the 3DMM comprises a second mesh model of the second portion of the 3DMM.

Aspect 13. The method of Aspect 12, further comprising: generating the first mesh model of the first portion of the 3DMM; and generating the second mesh model of the second portion of the 3DMM, wherein the first mesh model of the second portion of the 3DMM is generated independently from the second mesh model of the first portion of the 3DMM.

Aspect 14. The method of Aspect 13, further comprising: generating the first mesh model using a first view specific ML model of the ML model; and generating the second mesh model using a second view specific ML model of the ML model.

Aspect 15. The method of Aspect 14, wherein the ML model is trained using a training ML model, and wherein the first view specific ML model and second view specific ML model are trained based on a comparison of the 3DMM and a training 3DMM generated by the training ML model.

Aspect 16. The method of any of Aspects 11-15, further comprising merging a first mesh of the first portion of the parametric model and a second mesh of the second portion of the parametric model to generate the parametric model.

Aspect 17. The method of any of Aspects 11-16, wherein the information for the first portion of the parametric model comprises a first set of coefficients for generating a mesh model of the first portion of the parametric model, and wherein the information for the second portion of the parametric model comprises a second set of coefficients for generating a mesh model of the second portion of the parametric model.

Aspect 18. The method of Aspect 17, wherein the first set of coefficients are generated by a first view specific ML model of the ML model, and wherein the second set of coefficients are generated by a second view specific ML model of the ML model.

Aspect 19. The method of Aspect 18, wherein the ML model is trained using a training ML model, and wherein the first view specific ML model and second view specific ML model are trained based on a comparison of the parametric model and a training parametric model generated by the training ML model.

Aspect 20. The method of any of Aspects 17-19, further comprising merging the first set of coefficients and the second set of coefficients for generating the parametric model.

Aspect 21. A non-transitory computer-readable medium having stored thereon instructions that, when executed by at least one processor, cause the at least one processor to perform any of the operations of Aspects 11-20.

Aspect 22: An apparatus comprising one or more means for performing any of the operations of Aspects 11 to 21.

Aspect 23. An apparatus for generating a mesh model, comprising: at least one memory; and at least one processor coupled to the at least one memory, wherein the at least one processor is configured to: generate, based on a plurality of frames, a first portion of a parametric model of a face using a first machine learning (ML) model; generate, based on the plurality of frames, a second portion of the parametric model of the face using a second ML model, wherein the first portion of the parametric model is generated independently from the second portion of the parametric model; merge the first portion of the parametric model and the second portion of the parametric model to generate the parametric model; and output the parametric model.

Aspect 24. The apparatus of Aspect 23, wherein the parametric model comprises a 3D mesh model (3DMM), wherein the first portion of the 3DMM comprises a first mesh model of the first portion of the 3DMM, and wherein the second portion of the 3DMM comprises a second mesh model of the second portion of the 3DMM.

Aspect 25. The apparatus of Aspect 24, wherein the at least one processor is configured to: generate the first mesh model of the first portion of the 3DMM; and generate the second mesh model of the second portion of the 3DMM, wherein the first mesh model of the first portion of the 3DMM is generated independently from the second mesh model of the second portion of the 3DMM.

Aspect 26. The apparatus of Aspect 25, wherein the first ML model comprises a a first view specific ML model, and wherein the second ML model comprises a second view specific ML model.

Aspect 27. The apparatus of Aspect 26, wherein the at least one processor is configured to generate a training 3DMM using a third ML model, and wherein the first view specific ML model and second view specific ML model are trained based on a comparison of the 3DMM and the training 3DMM generated by the third ML model.

Aspect 28. The apparatus of any of Aspects 23-27, wherein the at least one processor is configured to merge a first mesh of the first portion of the parametric model and a second mesh of the second portion of the parametric model to generate the parametric model.

Aspect 29. The apparatus of any of Aspects 23-28, wherein the first portion of the parametric model comprises a first set of coefficients for generating a mesh model of the first portion of the parametric model, and wherein the second portion of the parametric model comprises a second set of coefficients for generating a mesh model of the second portion of the parametric model.

Aspect 30. The apparatus of Aspect 29, wherein the first set of coefficients are generated by a first view specific ML model, and wherein the second set of coefficients are generated by a second view specific ML model.

Aspect 31. The apparatus of any of Aspects 29-30, wherein the at least one processor is configured to merge the first set of coefficients and the second set of coefficients for generating the parametric model.

Aspect 32. The apparatus of any of Aspects 23-31, wherein the first ML model and second ML model are trained using a third ML model, and wherein the first ML model and second ML model are trained based on a comparison of the parametric model and a training parametric model generated by the third ML model.

Aspect 33. A method for generating a mesh model, comprising: generating, based on a plurality of frames, a first portion of a parametric model of a face using a first machine learning (ML) model; generating, based on the plurality of frames, a second portion of the parametric model of the face using a second ML model, wherein the first portion of the parametric model is generated independently from the second portion of the parametric model; merging the first portion of the parametric model and the second portion of the parametric model to generate the parametric model; and outputting the parametric model.

Aspect 34. The method of Aspect 33, wherein the parametric model comprises a 3D mesh model (3DMM), wherein the first portion of the 3DMM comprises a first mesh model of the first portion of the 3DMM, and wherein the second portion of the 3DMM comprises a second mesh model of the second portion of the 3DMM.

Aspect 35. The method of Aspect 34, further comprising: generating the first mesh model of the first portion of the 3DMM; and generating the second mesh model of the second portion of the 3DMM, wherein the first mesh model of the first portion of the 3DMM is generated independently from the second mesh model of the second portion of the 3DMM.

Aspect 36. The method of Aspect 35, wherein the first mesh model comprises a first view specific ML model, and wherein the second mesh model comprises a second view specific ML model.

Aspect 37. The method of Aspect 36, further comprising generating a training 3DMM using a third ML model, and wherein the first view specific ML model and second view specific ML model are trained based on a comparison of the 3DMM and the training 3DMM generated by the third ML model.

Aspect 38. The method of any of Aspects 33-37, further comprising merging a first mesh of the first portion of the parametric model and a second mesh of the second portion of the parametric model to generate the parametric model.

Aspect 39. The method of any of Aspects 33-38, wherein the first portion of the parametric model comprises a first set of coefficients for generating a mesh model of the first portion of the parametric model, and wherein the second portion of the parametric model comprises a second set of coefficients for generating a mesh model of the second portion of the parametric model.

Aspect 40. The method of Aspect 39, wherein the first set of coefficients are generated by a first view specific ML model, and wherein the second set of coefficients are generated by a second view specific ML model.

Aspect 41. The method of any of Aspects 39-40, further comprising merging the first set of coefficients and the second set of coefficients for generating the parametric model.

Aspect 42. The method of any of Aspects 33-41, wherein the first ML model and second ML model are trained using a third ML model, and wherein the first ML model and second ML model are trained based on a comparison of the parametric model and a training parametric model generated by the third ML model.

Aspect 43. A non-transitory computer-readable medium having stored thereon instructions that, when executed by at least one processor, cause the at least one processor to perform any of the operations of Aspects 33-42.

Aspect 44: An apparatus comprising one or more means for performing any of the operations of Aspects 33-43.

What is claimed is:

1. An apparatus for generating a mesh model, comprising:
at least one memory; and
at least one processor coupled to the at least one memory, wherein the at least one processor is configured to:
generate, based on a plurality of frames, a first portion of a parametric model of a face using a first machine learning (ML) model;
generate, based on the plurality of frames, a second portion of the parametric model of the face using a second ML model, wherein the first portion of the parametric model is generated independently from the second portion of the parametric model;
merge the first portion of the parametric model and the second portion of the parametric model to generate the parametric model; and
output the parametric model.

2. The apparatus of claim 1, wherein the parametric model comprises a 3D mesh model (3DMM), wherein the first portion of the 3DMM comprises a first mesh model of the first portion of the 3DMM, and wherein the second portion of the 3DMM comprises a second mesh model of the second portion of the 3DMM.

3. The apparatus of claim 2, wherein the at least one processor is configured to:
generate the first mesh model of the first portion of the 3DMM; and
generate the second mesh model of the second portion of the 3DMM, wherein the first mesh model of the first portion of the 3DMM is generated independently from the second mesh model of the second portion of the 3DMM.

4. The apparatus of claim 3, wherein the first ML model comprises a first view specific ML model, and wherein the second ML model comprises a second view specific ML model.

5. The apparatus of claim 4, wherein the at least one processor is configured to generate a training 3DMM using a third ML model, and wherein the first view specific ML model and second view specific ML model are trained based on a comparison of the 3DMM and the training 3DMM generated by the third ML model.

6. The apparatus of claim 1, wherein the at least one processor is configured to merge a first mesh of the first portion of the parametric model and a second mesh of the second portion of the parametric model to generate the parametric model.

7. The apparatus of claim 1, wherein the first portion of the parametric model comprises a first set of coefficients for generating a mesh model of the first portion of the parametric model, and wherein the second portion of the parametric model comprises a second set of coefficients for generating a mesh model of the second portion of the parametric model.

8. The apparatus of claim 7, wherein the first set of coefficients are generated by a first view specific ML model, and wherein the second set of coefficients are generated by a second view specific ML model.

9. The apparatus of claim 7, wherein the at least one processor is configured to merge the first set of coefficients and the second set of coefficients for generating the parametric model.

10. The apparatus of claim 1, wherein the first ML model and second ML model are trained using a third ML model, and wherein the first ML model and second ML model are trained based on a comparison of the parametric model and a training parametric model generated by the third ML model.

11. A method for generating a mesh model, comprising:
generating, based on a plurality of frames, a first portion of a parametric model of a face using a first machine learning (ML) model;
generating, based on the plurality of frames, a second portion of the parametric model of the face using a second ML model, wherein the first portion of the parametric model is generated independently from the second portion of the parametric model;
merging the first portion of the parametric model and the second portion of the parametric model to generate the parametric model; and
outputting the parametric model.

12. The method of claim 11, wherein the parametric model comprises a 3D mesh model (3DMM), wherein the first portion of the 3DMM comprises a first mesh model of the first portion of the 3DMM, and wherein the second portion of the 3DMM comprises a second mesh model of the second portion of the 3DMM.

13. The method of claim 12, further comprising:
generating the first mesh model of the first portion of the 3DMM; and
generating the second mesh model of the second portion of the 3DMM, wherein the first mesh model of the first portion of the 3DMM is generated independently from the second mesh model of the second portion of the 3DMM.

14. The method of claim 13, wherein the first mesh model comprises a first view specific ML model, and wherein the second mesh model comprises a second view specific ML model.

15. The method of claim 14, further comprising generating a training 3DMM using a third ML model, and wherein the first view specific ML model and second view specific ML model are trained based on a comparison of the 3DMM and the training 3DMM generated by the third ML model.

16. The method of claim 11, further comprising merging a first mesh of the first portion of the parametric model and a second mesh of the second portion of the parametric model to generate the parametric model.

17. The method of claim 11, wherein the first portion of the parametric model comprises a first set of coefficients for generating a mesh model of the first portion of the parametric model, and wherein the second portion of the parametric model comprises a second set of coefficients for generating a mesh model of the second portion of the parametric model.

18. The method of claim 17, wherein the first set of coefficients are generated by a first view specific ML model, and wherein the second set of coefficients are generated by a second view specific ML model.

19. The method of claim 17, further comprising merging the first set of coefficients and the second set of coefficients for generating the parametric model.

20. The method of claim 11, wherein the first ML model and second ML model are trained using a third ML model, and wherein the first ML model and second ML model are trained based on a comparison of the parametric model and a training parametric model generated by the third ML model.
